(19) United States
(12) Patent Application Publication
(10) Pub. No.: US 2022/0114688 A1
(43) Pub. Date: Apr. 14, 2022

(54) DIGITIZED AUTOMATIC, FIRE, SMOKE, AND EGRESS DOOR INSPECTION SYSTEM AND METHODS

(71) Applicant: Emrgtech IQ, Inc. d/b/a FacilitiesIQ, Pittsburgh, PA (US)

(72) Inventors: George C. Parks, Allison Park, PA (US); Stephen Saxton, Pittsburgh, PA (US); Dianne Wainwright, Pittsburgh, PA (US); Ronald Pickett, Newmarket (CA)

(73) Assignee: Emrgtech IQ, Inc. d/b/a FacilitiesIQ, Pittsburgh, PA (US)

(21) Appl. No.: 17/500,009

(22) Filed: Oct. 13, 2021

Related U.S. Application Data
(60) Provisional application No. 63/090,738, filed on Oct. 13, 2020.
(60) Provisional application No. 63/179,943, filed on Apr. 26, 2021.

(51) Int. Cl. G06Q 50/26; G06Q 30/00

(52) U.S. Cl. CPC G06Q 50/265; G06F 3/0482; G06Q 30/018

(57) ABSTRACT

DoorIQ is a software-as-a-service solution consisting of two core components. First, DoorIQ is an inspection app optimized for smartphone (either Apple or Android-powered smart devices) and the second is a cloud-based web application. The inspection app allows a certified automatic, fire, smoke, and/or egress door inspector to perform a best practice inspection for an automatic, fire, smoke, and/or egress door and enter that digitally on the smart device. The results of the inspection are stored in a database. The cloud-based web application allows inspectors, office managers and business owners to review prior inspections, add and manage certified inspectors to be able to use the app, and assign a form of payment for the use of the inspection app. The data, information, and results of inspections can then be distributed by email to property owners/managers and Authorities Having Jurisdiction (AHJ) to evidence compliance or non-compliance with codes and regulations.

### CLAIM OF PRIORITY

This application claims priority to and incorporates by reference in their entirety both U.S. Provisional Application Ser. No. 63/090738, filed on Oct. 13, 2020 by Parks, et al., entitled, “Digitized Automatic Door Inspection System and Methods” (hereinafter “Automatic Door Provisional Application”) and U.S. Provisional Application Ser. No. 63/179943, filed on Apr. 26, 2021 by Parks, et al., entitled, “Digitized Fire, Smoke, and Egress Door Inspection System and Methods” (hereinafter “Fire Door Provisional Application”).

### FIELD

This invention relates to a system and method of capturing, organizing, storing, and distributing data, information, and results related to automatic, fire, smoke, and/or egress door inspections in buildings and at facilities by certified inspectors.

### BACKGROUND OF THE INVENTION

Automatic doors are regularly inspected at millions of buildings and facilities globally. The American Association of Automatic Door Manufacturers (AAADM) is a trade association of manufacturers of automatic door systems. AAADM was founded in 1994 with the following mission: to advance the interests of the automatic door systems industry; to increase education, training and professionalism among installers and service providers; and to generally promote the safe use of automatic doors. ANSI national consensus standard defines and governs requirements for automatic door systems. AAADM administers a program to certify automatic door inspectors.

AAADM has developed a certification and training program for inspectors and technicians. Classes are held on a regular basis in the United States and Canada. AAADM-certified inspectors are trained and qualified to conduct annual inspections in accordance with current industry standards.

Automatic doors have an outstanding safety record with more than 50 billion safe door openings and closings every year in the United States alone. Automatic doors offer accessibility and entry convenience at airports, hospitals and stores everywhere. With proper installation, annual or semi-annual inspections by AAADM-certified inspectors, and daily safety checks by premise owners, automatic doors provide safe, convenient access for everyone who's ever struggled with a manual door while carrying a package and for the handicapped and elderly. In the current environment of the COVID-19 pandemic, touchless, automatic doors play an even more important role in public health and safety.

All members of AAADM make their automatic doors and components in compliance with the ANSI/BHMA Standard for Power Operated Pedestrian Doors, ANSI/BHMA A156.10-2011. This national consensus standard defines and governs such things as installation, sensing devices, and safety requirements for automatic doors.

Automatic door systems should be checked annually, and sometimes semi-annually, by an inspector who has been certified by AAADM. Through each inspection, the door system can be checked for compliance with the latest industry standards and tested for proper operability. Inspections have traditionally been accomplished via paper forms, with one copy being mailed to AAADM and another mailed to the property owner/manager. Inspectors are trained in filling in the forms. However, information is sometimes missing, rendering a form incomplete, and forms may be easily lost, damaged, or illegible. Also, the property manager/owner has no searchable database of records for its doors and has to search through paper copies for retrieval of past inspection information, assuming the paper copies can even be located in readable condition.

Similar to automatic doors, fire, smoke, and/or egress doors are regularly inspected at millions of buildings and facilities globally pursuant to fire codes and regulations. The National Fire Protection Association (“NFPA”) (https//www.nfpa.org/) requires facilities to complete annual, and sometimes semi-annual, fire, smoke, and/or egress door inspections and testing. The 2012 edition of the Life Safety Code (NFPA 101 and NFPA 80), incorporated by reference, generally governs fire door inspections and testing. Sections 18.2.2.2.1/19.2.2.2.1 requires compliance with Section 7.2.1, and Section 7.2.1.15.2 requires compliance with NFPA 80: Standard for Fire Doors and Other Opening Protectives (2012 edition, Section 5.2). Life Safety Code Section 7.2.1.15.2 requires all fire, smoke, and/or egress doors to be inspected and tested annually, and sometimes semi-annually, including doors such as:

Doors with fire protection rating labels

Door assemblies in exit enclosures—typically stairwells and exit passageways

Door assemblies in smoke compartment walls

Hazardous rooms with rated doors

Swinging fire doors with builders' hardware

Smoke doors (fire-rated and nonrated door assemblies)

Egress doors (fire-rated and nonrated door assemblies)

The following NFPA codes, available at https://www.nfpa.org/, are relevant to fire, smoke, and/or egress doors and are incorporated herein by reference in their entirety in their latest editions, which include, but may not be limited to: NFPA 80: Standard for Fire Doors and Other Opening Protectives; NFPA 252: Standard Methods of Fire Tests of Door Assemblies; NFPA 288: Standard Methods of Fire Tests of Horizontal Fire Door Assemblies Installed in Horizontal Fire Resistance-Rated Assemblies; and NFPA 105: Standard for Smoke Door Assemblies and Other Opening Protectives.

The 2013 edition of NFPA 80 (2013) 5.2.3.5.2, incorporated by reference, provides 13 inspection points for fire doors, including swinging fire doors with builders' hardware. FIRE DOORS —13 INSPECTION POINTS PER NFPA 80 (2013) 5.2.3.5.2

Swinging fire door with builders hardware will be inspected to verify the following:

1. Labels are clearly visible and legible.

2. No open holes or breaks exist in surfaces of either the door or frame.

3. Glazing, vision light frames, and glazing beads are intact and securely fastened in place, if so equipped.

4. The door, frame, hinges, hardware and non-combustible threshold are secured, aligned, and in working order with no visible signs of damage.

5. No parts are missing or broken.

6. Door clearances do not exceed clearances listed in 4.8.4 and 6.3.1.7.

7. The self-closing device is operational; that is, the active door completely closes when operated from the full open position.

8. If a coordinator is installed, the inactive leaf closes before the active leaf.

9. Latching hardware operates and secures the door when it is in the closed position.

10. Auxiliary hardware items, which interfere or prohibit operation, are not installed on the door and frame.

11. No field modifications to the door assembly have been performed that void the label.

12. Meeting edge protection, gasketing and edge seals, where required, are inspected to verify their presence and integrity.

13. Signage affixed to a door meets the requirements listed in 4.1.4.

The 2016 edition of NFPA 105 (2016) 5.2.4.4.2, incorporated by reference, provides 18 inspection points for smoke doors, including fire-rated and nonrated door assemblies. SMOKE DOORS—18 INSECTION POINTS PER NFPA 105 (2016) 5.2.4.4.2

Fire-rated and nonrated door assemblies will be inspected to verify the following:

1. Labels on fire-rated smoke door assemblies are clearly visible and legible and bear the “S” label marking.

2. Door leaves without fire protection ratings comply with 6.3.1.

3. Door frames comply with 6.3.2.

4. Gasketing along the vertical edges of the door and across the top of the door and, where required, at meeting edges of pairs of doors forms a continuous seal that is not cut, notched, or otherwise modified to accommodate other hardware items.

5. Gasketing materials, where required, re intact and close the gaps between the door and frame to seal the door opening against the passage of smoke.

6. Doors installed in pressurized applications have a bottom seal, where required.

7. Doors equipped with bottom seals that automatically project to fully seal the gap under the door in the closed position do not interfere with the swinging of the door when retracted or the closing of the door when projected.

8. No open holes or breaks exist in the surfaces of either the door or the frame.

9. Glazing, vision light frames, and glazing beads are intact and securely fastened in place, is so equipped.

10. Gazing materials and vision light kits comply with Sections 6.5 and 6.6.

11. Glazing materials, vision light kits, and glazing beads are continuously sealed.

12. The door, frame, hinges, and other hardware are secured, aligned, and in working order with no visible signs of damage.

13. No parts are missing or broken.

14. Door clearances do not exceed dimensions listed in the 6.3.3 when measured on the pull side of the door(s).

15. The self-closing device is operational; that is, the active door completely closes when operated from the full open position.

16. If a coordinator is installed, the inactive leaf closes before the active leaf.

17. Where positive latching is required, latching hardware operates and secures the door when the door is in the closed position.

18. Where door leaves, other than doors arranged for automatic closing, are permitted to be held open with friction door holder devise, the door holder devices comply with 6.3.6.6.

The 2015 edition of NFPA 101 (2015) 7.2.1.15.6, incorporated by reference, provides 13 inspection points for egress doors, including fire-rated and nonrated door assemblies. EGRESS DOORS—13 INSPECTION POINTS PER NFPA 101 (2015) 7.2.1.15.6

Fire-rated and nonrated door assemblies will be inspected to verify the following:

1. Floor space on both sides of the openings is clear of obstructions, and door leaves open fully and close freely.

2. Forces required to set door leaves in motion and move to fully open position do not exceed the requirements in 7.2.1.4.5.

3. Latching and locking devices comply with 7.2.1.5.

4. Releasing hardware devices are installed in accordance with 7.2.1.5.10.1.

5. Door leaves of paired openings are installed in accordance with 7.2.1.5.11.

6. Door closers are adjusted properly to control the closing speed of door leaves in accordance with accessibility requirements.

7. Projection of door leaves into the path of egress does not exceed the encroachment permitted by 7.2.1.4.3.

8. Powered door openings operate in accordance with 7.2.1.9.

9. Signage required by 7.2.1.4.1(3), 7.2.1.5.5, 7.2.1.6, and 7.2.1.9 is intact and legible.

10. Door openings with special locking arrangements function in accordance with 7.2.1.6.

11. Security devices that impede egress are not installed on openings, as required by 7.2.1.5.12.

12. Where required by 7.2.2.5.5.7, door hardware marking is present and intact.

13. Emergency lighting on access-controlled egress doors and doors equipped with delayed-egress locking systems is present and functioning in accordance with Section 7.9.

NFPA recommends that a facility identify all doors to be inspected on a drawing/layout of the facility to track inspections. It is recommended that each door at the facility be inspected annually, and sometimes semi-annually, and that the record of that inspection be maintained for a period of three years.

The Door Security & Safety Foundation at www.doorsecuritysafety.org, incorporated by reference, provides other resources in the fire, smoke, and egress door inspection industry. Inspectors of fire, smoke, and/or egress doors must be certified and trained. Classes are held on a regular basis in the United States and Canada. NFPA is one agency that provides certification and training. ALOA Security Professionals Association, Inc. (“ALOA”) is another organization that provides certification and training. Certified inspectors are trained and qualified to conduct inspections, annually and semi-annually, in accordance with current industry standards. Door and Hardware Institute (“DHI” at https://www.dhi.org/) is another association serving door security and safety professionals in the non-residential construction industry.

For ease of reference throughout, the term “Certifying Body,” may be used to describe NFPA, AAADM, ALOA, DHI, and/or any other relevant agency or organization in the inspection, certification, and regulation of regularly inspected doors and in the training and certification of fire door inspectors.

Fire, smoke, and/or egress doors should be checked annually, and sometimes semi-annually, by a certified inspector. Through each inspection, the door can be checked for compliance with the latest industry standards and tested for proper operability. Inspections have traditionally been accomplished via paper forms, with one copy being mailed to the Authority Having Jurisdiction (AHJ) and another mailed to the property owner/manager. NFPA codes define the AHJ as “an organization, office, or individual responsible for enforcing the requirements of a code or standard, or for approving equipment, materials, an installation, or a procedure.” This definition is also elaborated on in the annex of the codes, a portion of which states, “Where public safety is primary, the AHJ may be a federal, state, local, or other regional department or individual such as a fire chief; fire marshal; chief of a fire prevention bureau, labor department, or health department; building official; electrical inspector; or others having statutory authority. For insurance purposes, an insurance inspection department, rating bureau, or other insurance company representative may be the AHJ.”

Inspectors are trained in filling in the paper forms. However, information is sometimes missing, rendering a form incomplete, and forms may be easily lost, damaged, or illegible. Also, the property manager/owner has no searchable database of records for its doors and has to search through paper copies for retrieval of past inspection information, assuming the paper copies can even be located in readable condition. Further, the paper forms do not provide any means by which the specific location of each door and photographs of each door can be captured to evidence compliance or non-compliance with fire codes and regulations.

There is a need for a digitized system and method that captures, organizes, stores, and distributes complete and legible data, information, and results related to automatic, fire, smoke, and/or egress door inspections in buildings and at facilities by certified inspectors.

### SUMMARY OF THE INVENTION

The present invention involves a system and method of capturing, organizing, storing, and distributing data, information, and results related to automatic, fire, smoke, and/or egress door inspections in one or more buildings and at one or more facilities by one or more certified inspectors. One embodiment of the invention includes a method of: (1) having a first inspector physically inspect a first door on site at a first facility, wherein the first inspector uses a remote smart device to enter data about the first door, including selecting a type of fire door being inspected, associating the first door to a first customer, entering real time data about the first door, including at least the information that had previously in the prior art been collected by paper forms about that particular door to be inspected as per code and regulation, including the door's operation, recording the GPS location of the first door, and taking photographs and/or videos of the first door; (2) transmitting the entered data, information, and results about the first door to a database; and (3) allowing the first customer to access the entered data in the database through a web-based user interface.

Another embodiment of the invention includes a system of capturing, organizing, storing, and distributing data, information, and results related to door inspections for doors that need to be regularly inspected according to code or regulation in one or more buildings at one or more facilities by one or more inspectors comprising: (1) a remote smart device associated with a first inspector, wherein the first inspector physically inspects one or more doors, wherein a first door is on site at a first facility, wherein the first inspector enters data about the first door using the remote smart device, including selecting a type of door being inspected, associating the first door to a first customer, entering real time data about the door, including at least the door's operation, recording the GPS location of the first door, and taking at least one of a photograph or video of the first door to evidence compliance or non-compliance with codes and regulations; (2) a database which receives and organizes the entered data about the first door from the remote smart device; and (3) a first customer device that allows the first customer to access the entered data in the database through a web-based user interface.

### BRIEF DESCRIPTION OF DRAWINGS

FIG. 1 is a method according to one embodiment of the invention of collecting and transmitting data associated with an inspection of a door.

FIG. 2 is a representative screenshot of an APP on a smart device that assists in the collecting of data associated with an inspection of a door according to one embodiment of the invention.

FIG. 3 is a representative screenshot of an APP on a smart device that assists in the collecting of data associated with an inspection of a door according to one embodiment of the invention.

FIG. 4 is a representative screenshot of an APP on a smart device that assists in the collecting of data associated with an inspection of a door according to one embodiment of the invention.

FIG. 5 is a representative screenshot of an APP on a smart device that assists in the collecting of data associated with an inspection of a door according to one embodiment of the invention.

FIG. 6 is a representative screenshot of an APP on a smart device that assists in the collecting of data associated with an inspection of a door according to one embodiment of the invention.

FIG. 7 is a representative screenshot of an APP on a smart device that assists in the collecting of data associated with an inspection of a door according to one embodiment of the invention.

FIG. 8 is a representative screenshot of an APP on a smart device that assists in the collecting of data associated with an inspection of a door according to one embodiment of the invention.

FIG. 9 is a representative screenshot of an APP on a smart device that assists in the collecting of data associated with an inspection of a door according to one embodiment of the invention.

FIG. 10 is a representative screenshot of an APP on a smart device that assists in the collecting of data associated with an inspection of a door according to one embodiment of the invention.

FIG. 11 is a representative screenshot of an APP on a smart device that assists in the collecting of data associated with an inspection of a door according to one embodiment of the invention.

FIG. 12 is a representative screenshot of an APP on a smart device that assists in the collecting of data associated with an inspection of a door according to one embodiment of the invention.

FIG. 13 is a representative screenshot of an APP on a smart device that assists in the collecting of data associated with an inspection of a door according to one embodiment of the invention.

FIG. 14 is a representative screenshot of an APP on a smart device that assists in the collecting of data associated with an inspection of a door according to one embodiment of the invention.

### DETAILED DESCRIPTION OF THE INVENTION

The present application, system, and methods can be used to inspect and organize data related to any door that should be inspected on a regular basis according to one or more codes or regulations. The present application, system, and methods are therefore not limited to the type of door being inspected. The present application, system, and methods are therefore not limited to any one governing body and are written to be comprehensive to the guidelines provided by any Certifying Body over any door being inspected. In other words, the herein presented system and methods are compatible within the established guidelines for any number of Certifying Bodies and are thus considered to be Certifying Body-neutral or Certifying Body-agnostic. Types of doors that are generally subject to codes and regulations include, but are not limited to automatic doors, fire doors, smoke doors, and egress doors.

There are at least seven types of generally recognized automatic doors, which include: POWER OPERATED FOLDING DOORS; POWER OPERATED LOW ENERGY DOORS; POWER OPERATED SLIDING DOORS; POWER OPERATED SWINGING DOORS (Excluding Double Egress); POWER OPERATED DOUBLE EGRESS SWINGING DOORS; POWER OPERATED LOW ENERGY SLIDING AND FOLDING DOORS; and MANUAL AND AUTOMATIC REVOLVING DOORS.

Prior art forms available from ANSI and/or AAADM generally governed the inspection of automatic doors and include paper forms that inspectors fill out on site. Other forms are known in the art for other regularly inspected doors and these forms collect similar information.

Paper forms have several draw-backs and issues, including the fact that paper copies can often be illegible, incomplete, lost, destroyed, and/or unauthenticated. Collecting the information digitally is advantageous because not only does it solve these problems, the information is stored and thus easily retrievable to be provided as evidentiary support in case of legal claims, damages, and/or accidents involving the automatic door. One of the main reasons for performing annual inspections is to preserve safe operability and document inspection reports to defend against legal claims and damages. Having the inspection information digitally stored solves many problems associated with the paper inspection door forms. Having a digitized, authenticated inspection report is a useful resource for litigation defense and is valuable to property managers and owners.

A fire-type door includes fire doors, smoke doors, and egress doors. For ease of reference, the term “fire door” or “fire-type door” will include fire doors, smoke doors, egress doors, and doors that can qualify as a fire door, and/or a smoke door, and/or an egress door. A fire door assembly inspector (FDAI) professional may be found using Door Security & Safety Foundation, an organization that provides education in the inspection of fire, smoke, and egress doors.

The 2016 edition of NFPA 105 Section 5.2.4.4 provides that:

“A record of all inspections and testing shall be provided that includes, but is not limited to, the following information:

1. Date of Inspection

2. Name of Facility

3. Name of person(s) performing inspections and testing

4. Company name and address of inspecting company

5. Signature of inspector of record

6. Individual record of each inspection and tested fire door assembly

7. Opening identifier and location of each inspected and tested fire door assembly

8. Type and description of each inspected and tested fire door assembly

9. Verification of visual inspection and functional operation

10. Listing of deficiencies in accordance with NFPA-80, 5.2.3 Section 5.3 and 5.4.”

There are several types of “fire-type” doors that can be inspected via the present system and method. These include:

Doors with fire protection rating labels;

Door assemblies in exit enclosures—typically stairwells and exit passageways;

Door assemblies in smoke compartment walls

Hazardous rooms with rated doors

Swinging fire doors with builders' hardware

Smoke doors (fire-rated and nonrated door assemblies)

Egress doors (fire-rated and nonrated door assemblies)

Prior art forms include paper forms that inspectors fill out on site. Examples of prior art paper forms include, but are not limited to, “Annual Fire Door Inspection” and “Annual Inspection and Testing of Fire and Smoke Door Assemblies,” both of which are available from NFPA.

Other forms are known in the art for the inspection of fire doors and these forms collect similar information. The application on the smart device collects the information requested in these examples of paper forms, in addition to information that cannot be captured by paper forms, including automatic date and time stamp, GPS-location information, and photograph(s) and/or video(s) of the door(s) being inspected.

Commercially available DoorIQ (https://www.myfacilitiesiq.com/dooriq) is a software-as-a-service solution consisting of two core components. First, DoorIQ is an inspection software application optimized for smartphone (either Apple or Android-powered smart devices) and the second is a cloud-based web application. The inspection software application is available to download and allows a certified fire door inspector to perform the industry-approved, best-practice inspection for a fire door on the smart device. The data, information, and results of the inspection, complete in all respects, are then captured digitally and stored in a database for future reference and use. Further, a PDF report of the inspection is created and is available to be sent via email to recipients designated by the inspector, such as the property owner/manager and Authority Having Jurisdiction. The second component, the cloud-based web application, allows inspectors, office managers and business owners to review prior inspections, compile inspection reports, add and manage certified inspectors to be able to use the application, and assign a form of payment for the use of the inspection application.

Other services for each customer may include:

The usage of the smart device app by their inspectors, including GPS-tracking feature for inspector accountability and the ability to upload photographs and/or videos to capture evidence of compliance or non-compliance with fire codes and regulations;

The usage of the web app by management;

The creation of the PDF inspection reports and unlimited email distribution for themselves, to the AHJ, and for the facility owner to facilitate legal and code-compliance requirements;

The cloud-based storage of their inspection history and inspection reports for future reference and access;

The addition and deletion of inspectors from their approved roster of inspectors; and

Access to ongoing improvements and updates to the solution over time, including automatic updates to any agency's guidelines and/or certification or inspection requirements.

Inspection App on Smart Device

The present invention involves collecting the traditional inspection information via an app on a smart phone or tablet. This is completed by the inspector on site who is physically inspecting the one or more fire doors.

Unlike the paper form, the GPS location of the inspection will be stored along with the inspection report information (to be collected via the several steps detailed below) to evidence where work was completed and to assist with inspector accountability. This information is in the form of latitude and longitude coordinates. The GPS locator function may be automatically enabled so that the inspector does not have to perform any additional steps or enter any additional information during inspection. The GPS location information is thus associated with the inspector himself and with the inspected doors, as appropriate, which will be captured upon the inspector initiating the app at the inspection site.

Another piece of data that will automatically be captured is the date and time of the inspection, which will be captured upon the inspector initiating the app at the inspection.

Photographs and/or videos will also be captured by the inspector to evidence compliance or non-compliance with door codes and regulations.

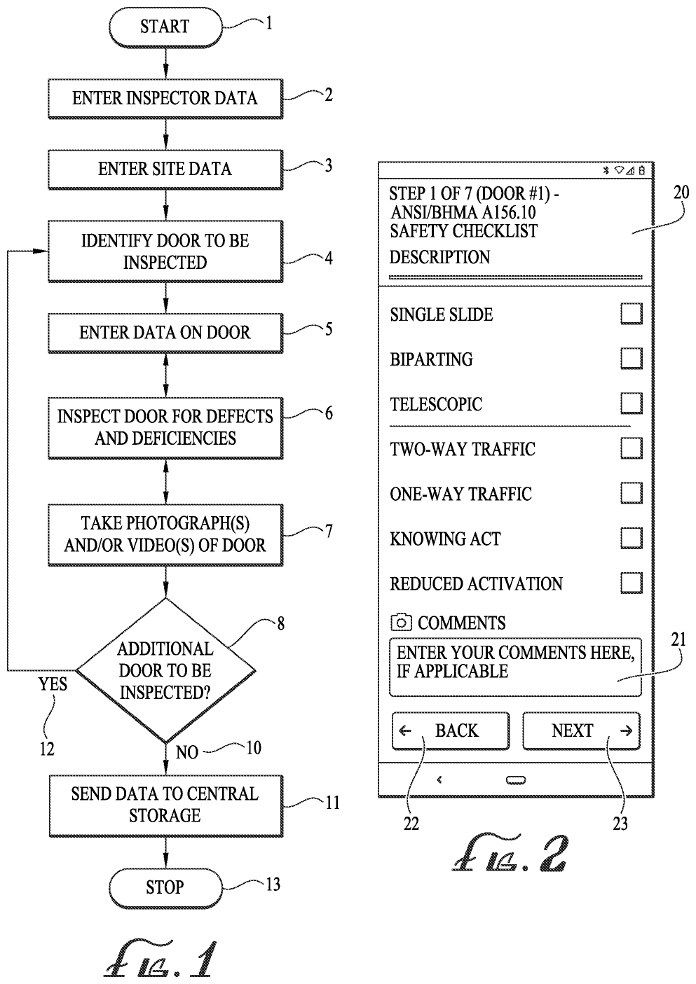

FIG. 1 details one method of the present invention. The general process will start 1 with each inspector downloading the app on their tablet or smartphone via a play store (Android) or app store (Apple). The first time the inspector uses the app, i.e., the initial set up 2, he/she will enter: profile information; Name; Certification Number and/or information; Passcode shared by inspector's employer; Email; Business Name; and Business Address. Initial set up 2 also includes an option for an inspector to upload one or more certifications or credentials received from one or more Certifying Body for both automatic and fire door certifications (e.g., AAADM and ALOA). The app will have a drop-down menu for the inspector to select from a number of Certifying Bodies. The app will allow the inspector to enter a certification number and/or a photograph and/or pdf of a certificate. The inspector may also upload an image of their company logo, to add an element of branding to the delivered pdf reports. After this initial set up (registration 2), the user can access the home screen, wherein the inspector can select “Start New Inspection” to begin a door inspection of one or more fire doors.

The home screen of the app may include 4 main options: (1) my account/profile; (2) view my submissions; (3) view local inspections; and (4) start new inspection. In “my account,” the inspector may upload and/or enter one or more of his credentials, as described in the initial set up 2, described in reference to FIG. 1. Also under the inspector's “profile” is a list of clients/customers associated with the inspector. For example, customers that he has previously inspected and/or customers that his employer has assigned for him. The terms “client” and “customer” are interchangeable herein. Under each customer is “Client Information” which includes address and contact information. The inspector may “add a client” or “skip client info” as appropriate. Under “view my submissions,” the inspector can review previously generated reports by door, daily, weekly, or similarly. Under “view local inspections,” the inspector may view given assignments or scheduling from his employer. Finally, “Start New Inspection” may be selected by the inspector before inspecting one or more doors.

Still with reference to FIG. 1, the inspector will enter either Order Number or Client Information as that data will identify the site location 3. If the instructor has not been instructed on which to enter, the inspector will enter Client Information and leave the Order Number section blank. The app will also have an option for the inspector to select “my current location as the facility location.” At step 3, the app will also automatically capture the site's GPS coordinates along with a date-time stamp.

The app will then populate any known Client Information associated with that particular location, such as address, client's name, and the name and number of doors to be inspected at that particular location. For example, if the inspector has been at the particular location before, his app will be able to retrieve that stored data and populate the Client Information. The inspector then selects “Start” to inspect the first door at that location.

At step 4, the inspector will identify the first door to be inspected. He will select the type of door being inspected from a drop-down menu, which will include at least automatic, fire, smoke, and egress. The inspector will then make a further selection of the type of door being inspected. For example, at FIG. 2, if the type of door being inspected is an automatic door, the inspector will the make a selection of: a single slide, biparting, telescope, two-way traffic, one-way traffic, knowing act, or reduced activation.

At step 5, the inspector will continue to enter data associated with the door into the app. The data associated with the door will depend on the type of door being inspected, but may generally include: closing speed if it is an automatic door or door clearances, the door's frame, and the door's operation if it is a fire-type door.

At step 6, the inspector will run site specific diagnostics on the door to continue to gather data associated with the door and enter it into the app, such as inspecting for deficiencies and defects. The data associated with the door will depend on the type of door being inspected, but may generally include: testing the door's sensor(s) if it is an automatic door or inspecting the door's clearances and other code-specific data to check for deficiencies and defects if it is a fire-type door. Any adjustments that the inspector makes to the door or its associated hardware or equipment will be detailed into the app.

At step 7, the inspector will take one or more photographs and/or videos of the door being inspected. The app has the ability to capture a visual for each prompt and may ask the inspector to take a photograph and/or video before advancing to the next screen. Alternatively, at the end of the inspection of this particular door being inspected, the app may prompt the inspector to select only the necessary visuals to be included in the report of the inspection. Once all the inspection data has been associated with the first door being inspected, the inspector will indicate that he has concluded with that first door. The app will then ask the inspector at step 8 if any additional doors at the same location need to be inspected.

At step 9, the app through the associated Client Information and/or the inspector can determine if any additional doors need to be inspected. If Yes 12, the app will redirect the inspector back to step 4 to identify the door to be inspected and repeat steps 4-7 on the next door to be inspected. If there are No 10 doors that are left to be inspected at this specific site, the app will prepare one or more reports. After inspector and/or site manager approval, the data in the form of one or more reports will be sent 11 to a central database. A report is preferably generated for each door inspected. A pdf of the report is reviewable on the inspector's smart device. The report may be transmitted from the inspector on site to up to 20 email addresses, including the property owner and the AHJ. The pdf report may be customized to show the inspection company's logo and the relevant credential logo (e.g., AADM, ALOA, DHI, etc.) The inspector will end/stop 13 his session on the app after all the doors at the same specific site have been inspected. The inspector will initiate a new session on his app at the next specific site.

FIGS. 2-7 illustrate representative screen shots of the app as it prompts an inspector to enter information for an automatic door inspection. FIGS. 8-14 illustrate representative screen shots of the app as it prompts an inspector to enter information for a fire-type door inspection. The present application is not limited to the representative examples or the “look and feel” of the app illustrated in FIGS. 2-14 and other ways to display, prompt the inspector, and collect the data are contemplated herein.

The inspector will enter “basic information” about the door, including the Asset or Serial number of the door. QR code reader may be used to scan the QR located on the automatic door. A photograph of the door may also be captured. Then, the inspector will select “next” or “OK” to proceed.

Next, there are a series of steps that the inspector will complete in order to inspect the first door. At the completion of each of the steps, the inspector will hit “next”, “submit”, “enter” or any other appropriate prompt. The inspector cannot advance from one step to another unless and until the necessary fields are completed. Unlike the paper form, the digitized form will always be legible and complete. Additionally, the app allows a user to go “back” to renter information if determined to be inaccurate. First, the inspector will enter information about the door type, such as, but not limited to: fire door, smoke door, egress door, automatic folding door, automatic low energy swinging door, automatic sliding door, automatic swinging door (excluding double egress), and automatic double egress swinging door.

Inspection of an Automatic Door

If a type of automatic door is selected, then according to FIG. 2, the sub-type of automatic door will then be entered under “Description” 20: “single slide”, “biparting”, “telescope”, “two-way traffic,” “one-way traffic”, “knowing act”, or “reduced activation.” Like every inspection step, an option to take a photograph and/or video is available. The inspector may be trained to write comments to explain any visual associated with any step of the inspection. Additionally, with every inspection step, the app allows for typed comments 21 regardless of associated photograph. After the appropriate selection of door type, the inspector may advance in the inspection by selection “next” 23 or go “back” to the previous screen 22.

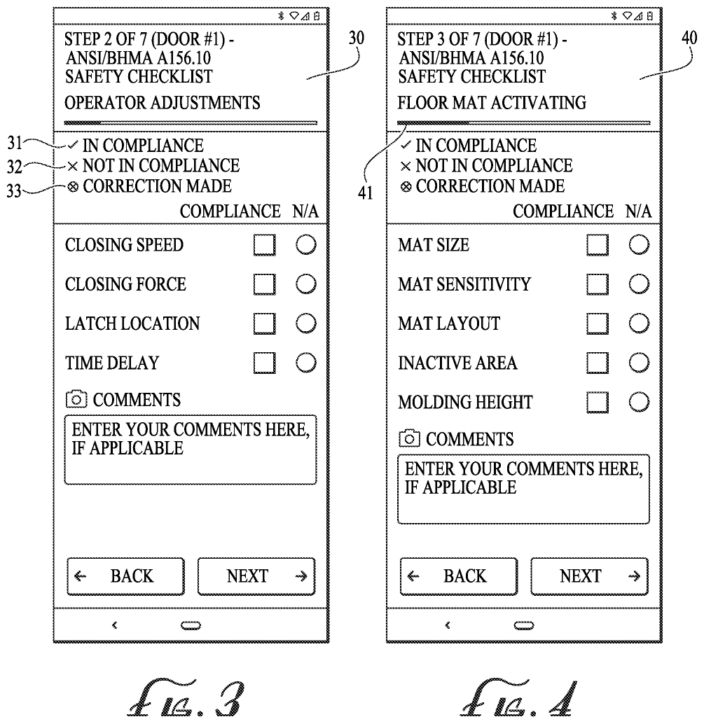

With reference to FIG. 3, the inspector will enter the “Operator Adjustments” 30 for each inspected feature: closing speed, closing force, latch location, and time delay. For example, each time the inspector selects a compliance item, the prompt will toggle between “In Compliance” 31, “Not In Compliance” 32, “Correction Made” 33. The operator may also select “N/A” if the data is not applicable to that specific door. As with any step, the inspector may optionally take a photograph and/or video and/or enter comments or notes.

Many times, the inspector may make a correction on site, during the inspection, i.e., an inspector may adjust closing force. That is what is contemplated under “Correction Made” 33. The app may not advance if a “Correction Made” 33 is selected before a written note is provided.

If the inspector finds that any feature is “Not in Compliance” 32, for example, and he needs to order a replacement part in which to make the feature in compliance, then the system will record that information and generate the appropriate Failed Inspection notifications and reports. Upon subsequent repairing of the door so that the feature is now “in compliance,” appropriate notifications, reports, and updates may be made. The repair may be tracked therefore by both the inspector and the customer via the customer web-based app.

Traditionally, the closing speed is something that the inspector measures with a stop watch at the inspection. As more and more automatic doors have sensors, it is contemplated that an accelerometer sensor may be used in connection with the app. It is contemplated that a Wi-Fi based accelerometer sensor be in communication with the app so as to automatically record closing speed and to also alert the customer-side app if the speed becomes outside of range. It is also contemplated that a Wi-Fi based sensor assessing temperature, humidity, and certain other elements be in communication with the app to alert the customer-side app if temperature, humidity, etc. become outside of normal range due to improper function of the door.

Next, with reference to FIG. 4, the inspector may enter the floor mat activating information 40. As more and more mats become replaced with presence sensors (next step), the Floor Mat Activating step may be changed, updated, or the like. The mat size, mat sensitivity, mat layout, inactive area, and molding height may be inspected in this step.

The inspector's percentage of progress through the inspection may be noted by the app at all steps of the inspection by the horizontal bar 41. Other ways of displaying percentage progress as are known in the art contemplated herein. As with any other step, the app may have the “In Compliance,” “Not in Compliance,” and “Correction Made” selections. As with any other step, the app may have a comment section and the ability to take one or more photographs and videos. In order to avoid unnecessary duplication, note that the Applicants will not repeat these common features and functionality for all steps, although it is specifically contemplated that it be available for all steps of the inspection (“Common Features”).

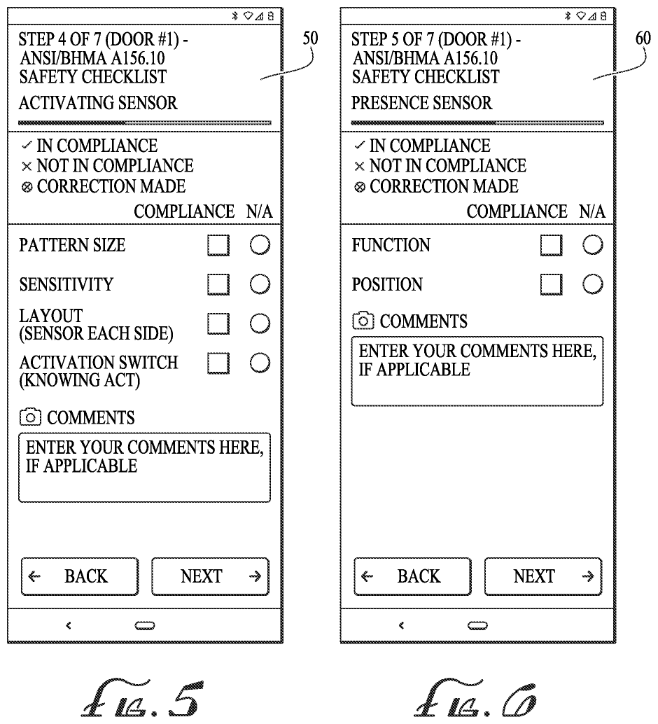

With reference to FIG. 5, the inspector may enter the activating sensor information 50. In this step, the inspector may enter the inspection information for the pattern size, the sensitivity, layout (sensor each side), and activation switch (knowing act). The Common Features are available at this step.

With reference to FIG. 6, the inspector will enter the presence sensor information 60. In this step, the function and position of the sensor are inspected and recorded. The Common Features are available at this step.

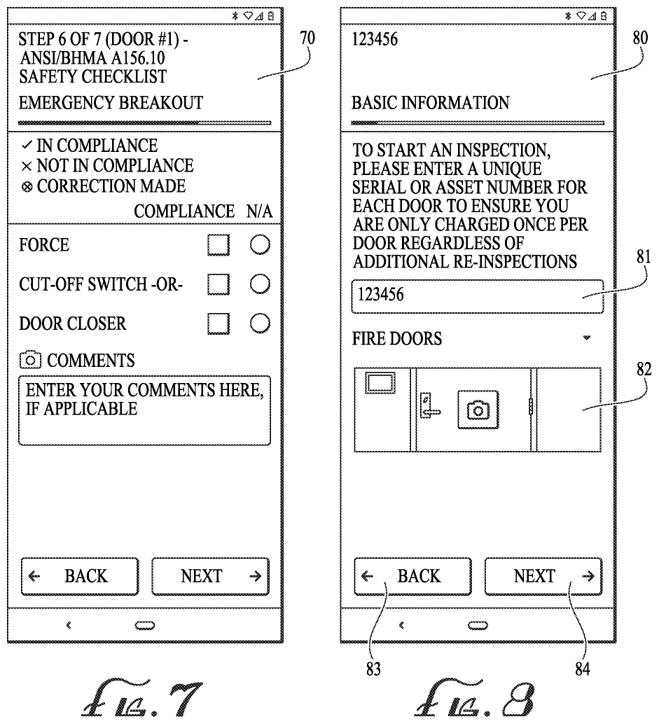

With reference to FIG. 7, the inspector will enter the emergency breakout information 70. In this step, the force, cut-off switch, and/or door closer are inspected and recorded. The Common Features are available at this step.

Other inspection information may be collected via one or more steps with one or more screens of the app. For example, the inspector may enter the signage information, such as whether the following signs are in compliance or not relevant to the door being inspected: “emergency-push”, “automatic door”, “activate switch”, “stand clear . . . ”, and/or “caution.” The Common Features are available at this step.

Next, for an automatic door or a fire door or for any other type of door being inspected, a completeness check may be performed. The app may prompt the inspector, “are all safety systems operation?” and/or “is the door properly labeled?” The app may simply ask a Y/N for these two types of completeness data. The Common Features are available at this step. The inspector may take one or more photographs or videos.

The inspector will have to select one or more photographs or videos associated with this door to be uploaded at this point. After the completion of uploading the one or more photographs and/or videos, the physical “inspection” steps performed by the inspector of the first door are substantially done. Next, the system will prompt the inspector to enter additional doors and then the inspector will review and submit his inspection.

The inspector is prompted if there are additional doors to be inspected at the same location. If so, the inspector “adds” a door to the same client. The inspector then repeats the physical inspection steps with information from the “additional” door(s) until there are no remaining doors to be inspected at that location. Once there are no additional doors to be inspected at this location, the inspector will review and sign.

After the inspector has completed the inspection, a report is generated for that door. The inspector may review that report before submitting it. After the inspector has a chance to review the report, and optionally reviewed or added more doors to the inspection, the inspector next obtains the consent of the customer.

The app may contain appropriate verbiage, such as: “As a qualified inspector, I have completed an inspection only on the above doors in your facility. This inspection is intended to assess the door's compliance with practical field tests designed to approximate the requirements of the current ANSI/BHMA standard A156.10, the American National Standard for Power Operated Doors. Individual manufacturers may have additional requirements or recommendations for their doors. It is strongly recommended to bring doors into compliance for safe operation.” On the customer consent screen, the app may ask the inspector if the customer is available. The app may also ask about the availability of the owner's manual.

Next, the inspector should present the AHJ language to the customer, check whether or not the customer has a manual, and then have the customer initial. After that, the customer should click “Sign.”

Both the inspector and the customer may sign on the screen. The screen may auto-rotate to allow space to sign at this step. The inspector signs side by side with the customer to acknowledge the customers signature and confirm that they completed the report. Once done, the inspector will click the arrow at the bottom right of the screen or otherwise advance to the next step.

The report may be prepared to be sent to one or more email recipients, including the inspector's and/or the customer's email and/or AHJ. The inspector may then submit reports. He can also view the submitted reports online from this screen. Finally, the inspector can select a feature that eliminates this last step by selecting “automatically submit reports.” The inspection is now complete for one or more doors at this facility. The inspector is then directed to return to the main screen.

An Inspection Report may be generated using the systems and methods of the present invention, a sample report may include the following information: Customer Order, Work Order, date and time, Status, Inspector information, client information, door information, Latitude and Longitude coordinates, and one or more images. Other formats may be used. The Inspection Report may include a photograph and the GPS locator information associated with the inspection. Note the “LAT” and “LNG” coordinates under the photograph of the door in the example Inspection Report above. All the captured data is populated in the Inspection Report, including the Customer Order, Work Order, Date, Status of the Inspection, Inspector information, Client information, and Door Information.

Data included in the Inspection Report includes the Inspection Results, Inspector/Operator Adjustments, Inspector Comments, Signage Results, Guide Rails Results, Floor Mat Results, Activating Sensor Results, Safety Sensor Results, Threshold Protection, and an overall Completeness Check.

Inspection of a Fire-Type Door

If a fire-type door is to be inspected, the inspector will enter the type of information seen in FIGS. 8-14. In a health care facility, such as a nursing home, the App will remind the inspector at appropriate times that “SNF/NF resident rooms do not require closers” and “Smoke Barrier doors do not require latches.”

If the user selects a “fire-type door,” information may be retrieved about that particular facility's fire-type doors. The facility is most likely to have multiple fire-type doors on the premises. The smart device app will communicate with the customer web-based app in order to retrieve a listing of all the fire-type doors at this particular facility. The inspector may be prompted to start at the top of the building and work his way down, door-by-door, floor-by-floor. There may be a map, layout, or drawing of the facility to help track the number of fire-type doors at the facility. Each particular fire-type door may be appropriately labeled such as by floor, stairwell, North, South, East, and West. For example, a name of a door may be Floor16stairwell2East. Other nomenclature may be used.

For each door, the user will be prompted to select a specific “fire-type” door:

Door with fire protection rating labels;

Door assembly in exit enclosures—typically stairwells and exit passageways;

Door assembly in smoke compartment walls

Hazardous room with rated door

Swinging fire door with builders' hardware

Smoke door (fire-rated and nonrated door assemblies); or

Egress door (fire-rated and nonrated door assemblies)

With reference to FIG. 8, the inspector may enter the Basic Information 80 about the fire-type door. The Asset or Serial number of the door 81 may be entered. QR code reader may be used to scan the QR located on the fire door. At this step, the inspector will also enter the type of fire-type door being inspected and choose from a drop-down menu: fire door, smoke door, or egress door. Note that the inspector can enter additional doors of the same or differing type once the first door has been inspected. Alternatively, the app may prompt the inspector through the multiple fire doors in the single facility. As with an automatic door inspection, with a fire-type door inspection, the Common Features are generally available at all steps of the inspection. For example, at 82, a photograph of the fire-type door may be taken. The app will have the ability to go “Back” 83 or advance “Next” 84.

There are a series of steps that the inspector may complete in order to inspect the first fire-type door. At the completion of each of the steps, the inspector will hit “next”, “submit”, “enter” or any other appropriate prompt. The inspector cannot advance from one step to another unless and until the necessary fields are completed. Unlike the paper form, the digitized form will always be legible and complete. Additionally, the app allows the user to go “back” to renter information if determined to be inaccurate.

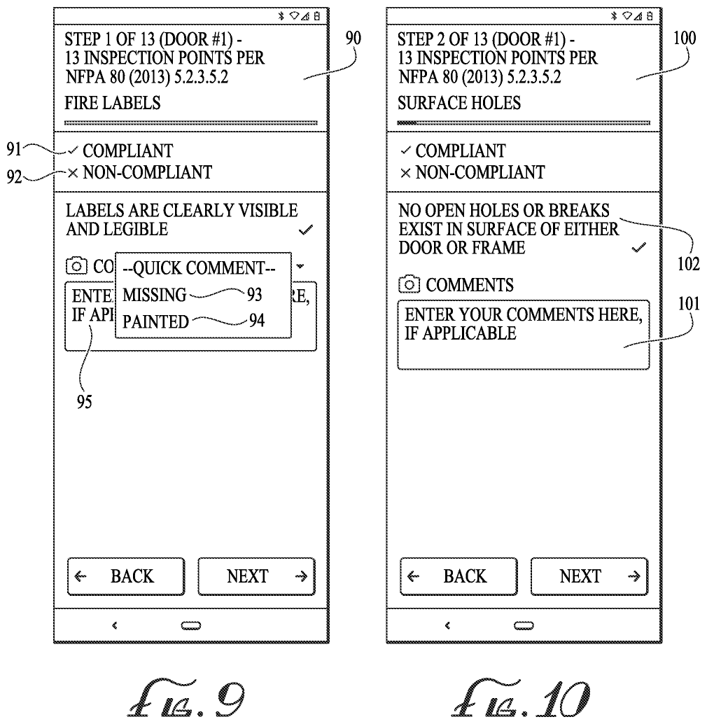

With reference to FIG. 9, Fire Label information 90 will be entered. Each time the inspector selects a COMPLIANCE item, the inspector will select between “Compliant” 91 or “Not Compliant” 92. A fire type door's label should be clearly visible and legible and not painted over. Therefore, a quick comment about the fire labels may be entered from a drop-down menu: “missing” 93 or “painted” 94. The inspector could also enter his own comment 95. A best practice may be for the inspector to enter more explanation even if the particular step has a drop-down menu for common remarks. A best practice is for the inspector to enter an explanation if any correction was made.

The Common Features are generally available, including the ability to take one or more photos and/or videos.

With reference to FIG. 10, the Surface Hole information 100 will be entered. The inspector will enter either “Compliant” or “Not Compliant” as he determines if there are breaks, gaps or holes in the door or frame 102. The inspector may write a comment 101. The Common Features are generally available.

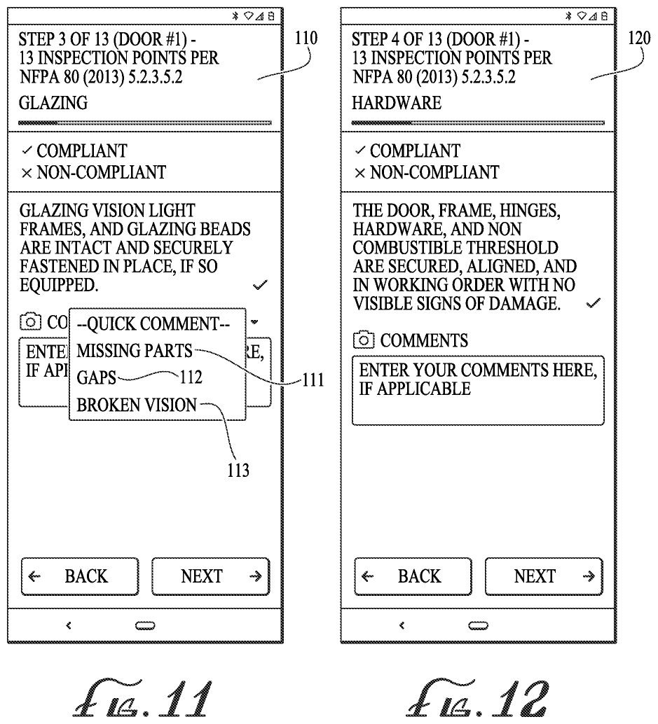

With reference to FIG. 11, the Glazing information 100 will be entered. The inspector will enter either “Compliant” or “Not Compliant” as he determines whether the glazing is compliant. The glazing vision light frames and glazing beads should be intact and should be securely fastened in placed. Therefore, a quick comment about the glazing may be entered from a drop-down menu: “missing parts” 111 or “gaps” 112 or “broken vision” 113. The inspector may select one or more comments from the drop-down menu as appropriate. A best practice may be for the inspector to enter more explanation even if the particular step has a drop-down menu for common remarks. The Common Features are generally available.

With reference to FIG. 12, the Hardware information 120 will be entered. The inspector will enter either “Compliant” or “Not Compliant” after he inspects the hardware. As an example of the verbiage, the app may say, “the door, frame, hinges, hardware, and non-combustible threshold are secured, aligned, and in working order with no visible signs of damage.” The Common Features are generally available.

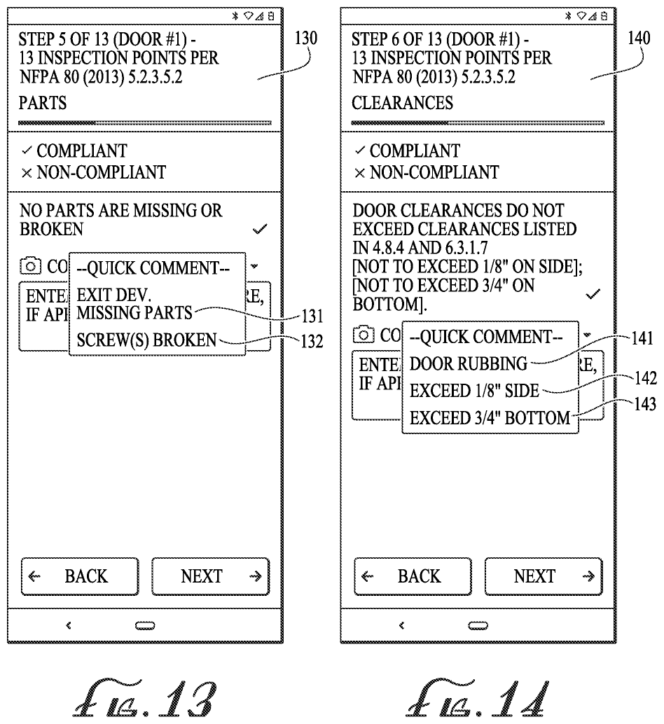

With reference to FIG. 13, the Parts information 130 will be entered. The inspector will enter either “Compliant” or “Not Compliant” after he inspects the parts. As an example of the verbiage, the app may say, “no parts are missing or broken.” Therefore, a quick comment about the parts may be entered from a drop-down menu: “exit dev. missing parts” 131 or “screw(s) broken” 132. The inspector may select one or more comments from the drop-down menu as appropriate. A best practice may be for the inspector to enter more explanation even if the particular step has a drop-down menu for common remarks. The Common Features are generally available.

With reference to FIG. 14, the Clearances information 140 will be entered. The inspector will enter either “Compliant” or “Not Compliant” after he inspects the clearances. As an example of the verbiage, the app may say, “door clearances do not exceed clearances listed in 4.8.4 and 6.3.1.7 [not to exceed ⅛″ on side]; [not to exceed ¾″ on bottom].” Therefore, a quick comment about the parts may be entered from a drop-down menu: “door rubbing” 141 or “exceed ⅛″ side” 142 or “exceed ¾ bottom” 143. The inspector may select one or more comments from the drop-down menu as appropriate. A best practice may be for the inspector to enter more explanation even if the particular step has a drop-down menu for common remarks. The Common Features are generally available.

Other general information may be collected about fire-type doors being inspected. The inspector may enter the door's rating if known. The inspector may enter information about the door's Operation, such as “swings freely”, “closes properly”, and/or “latches properly.” The inspector will enter the inspection results for each individual item, such as for example, the Operation, Frame, Door, Door Closer, Hinges, Flush Bolts, Lockset/ Hardware, Fire Exist Hardware, Signage, and Final Inspection Elements.

The Frame may be inspected. The inspector will see a screen associated with the frame. The inspector will enter information about “label present and legible”, “is secure”, “no open holes/breaks”, “frame not rusted through”, and/or “gaskets intact.”

Other ways of organizing the data is contemplated. For example, the inspector may enter information regarding “label present and legible”, “correct clearance (<¾″ bottom, <⅛″ other)”, “no open holes/breaks, “glazing/vision light frames intact”, “not damaged/delaminated door”, “door not rusted-through”, “no non-compliant field modification”, and/or “no visible signs of damage.”

The Door Closer may be inspected. The inspector will enter information regarding “all hardware installed”, “strike in good shape”, and/or “securely installed.” The Hinges may be inspected in connection with Parts 130 or separately. The inspector may enter information regarding “correct” and/or “securely installed.” The App may also prompt the inspector to enter any additional information about the Hinges.

Similarly, the Flush Bolts may be inspected with Parts 130 or separately. The inspector will select from “correct” and/or “securely installed.” The Lockset/Hardware may be inspected with Parts 130, with Hardware 120 or separately. The inspector may select from “all hardware installed”, “strike in good shape”, “securely installed” and/or “coordinator working properly.”

The Self-Closing information will be entered. The inspector will enter either “Compliant” or “Not Compliant” after he inspects the self-closing mechanism. As an example of the verbiage, the app may say, “the self-closing device is operational; that is, the active door completely closes when operated from the full open position. TEST (3) three times.” Therefore, a quick comment about the self-closing may be entered from a drop-down menu: “won't close” or “slams/bounces”. The inspector may select one or more comments from the drop-down menu as appropriate. A best practice may be for the inspector to enter more explanation even if the particular step has a drop-down menu for common remarks. The Common Features are generally available.

The Coordinator information will be entered. The inspector will enter either “Compliant” or “Not Compliant” after he inspects the coordinator mechanism. As an example of the verbiage, the app may say, “if a coordinator is installed, the inactive leaf closes before the active leaf.” Therefore, a quick comment about the coordinator may be entered from a drop-down menu: “parts missing” or “broken”. The inspector may select one or more comments from the drop-down menu as appropriate. A best practice may be for the inspector to enter more explanation even if the particular step has a drop-down menu for common remarks. The Common Features are generally available.

The Latching information will be entered. The inspector will enter either “Compliant” or “Not Compliant” after he inspects the latching mechanism. As an example of the verbiage, the app may say, “latching hardware operates and secures the door when it is in the closed position. Test (3) three times.” Therefore, a quick comment about the latching may be entered from a drop-down menu: “latch missing” or “latch broken”. The inspector may select one or more comments from the drop-down menu as appropriate. A best practice may be for the inspector to enter more explanation even if the particular step has a drop-down menu for common remarks. The Common Features are generally available.

The Obstruction information will be entered. The inspector will enter either “Compliant” or “Not Compliant” after he inspects whether is obstruction is present. As an example of the verbiage, the app may say, “auxiliary hardware items that interfere or prohibit operation are not installed on the door or frame.” Therefore, a quick comment about the existence of obstructions may be entered from a drop-down menu: “door prop” or “kick stop” or “obstacle.” The inspector may select one or more comments from the drop-down menu as appropriate. A best practice may be for the inspector to enter more explanation even if the particular step has a drop-down menu for common remarks. The Common Features are generally available.

The Modifications information will be entered. The inspector will enter either “Compliant” or “Not Compliant” after he inspects whether any modifications have been made. As an example of the verbiage, the app may say, “no field modifications to the door assembly have been performed that void the label.” Therefore, a quick comment about the modifications may be entered from a drop-down menu: “hold stop added” or “hardware removed” or “deadbolt added.” The inspector may select one or more comments from the drop-down menu as appropriate. A best practice may be for the inspector to enter more explanation even if the particular step has a drop-down menu for common remarks. The Common Features are generally available.

The Seals information will be entered. The inspector will enter either “Compliant” or “Not Compliant” after he inspects the seals of the fire-type door. As an example of the verbiage, the app may say, “meeting edge protection, gasketing and edge seals, where required, are inspected to verify their presence and integrity.” Therefore, a quick comment about the seals may be entered from a drop-down menu: “missing” or “torn” or “gaps.” The inspector may select one or more comments from the drop-down menu as appropriate. A best practice may be for the inspector to enter more explanation even if the particular step has a drop-down menu for common remarks. The Common Features are generally available.

The Signage information will be entered. The inspector will enter either “Compliant” or “Not Compliant” after he inspects the signage of the fire-type door. As an example of the verbiage, the app may say, “signage affixed to a door meets the requirements listed in 4.1.4 [not to exceed 5% of door face]; [can only be attached by means of adhesive].” Therefore, a quick comment about the signage may be entered from a drop-down menu: “signs screwed on” or “exceeds” or “sign on vision.” The inspector may select one or more comments from the drop-down menu as appropriate. A best practice may be for the inspector to enter more explanation even if the particular step has a drop-down menu for common remarks. The Common Features are generally available.

The Final Inspection Elements will be inspected. The inspector will select from “no items that interfere installed”, “no non-compliant field modification”, “door has appropriate signage”, and/or “any signage is properly affixed.”

Many times, the inspector may make a correction or adjustment on site, during the inspection, i.e., an inspector may adjust the signage, if qualified or certified to do so. The app will prompt the inspector to enter any “corrections made.” The App will prompt the inspector to enter any additional comments that haven't already been addressed through the process.

For example, here are some commonly observed deficiencies found on swinging fire doors with builders' hardware:

1. Painted or missing fire door labels

2. Poor clearance dimensions around the perimeter of the door in the closed position

3. Kick down door holders

4. Auxiliary hardware items that interfere with the intended function of the door (barrel bolts and dead bolts, etc.)

5. Fire doors blocked to stay in the open position

6. Area surrounding the fire door assembly blocked by furniture, equipment and/or boxes

7. Broken, defective or missing hardware items (latch bolts and/or strike plated, closer arms, cover plates, etc.)

8. Fire exit hardware installed on doors that are not labeled for sue with fire exit hardware

9. Missing or incorrect fasteners

10. Bottom flush bolts that do not project ½″ into the strike

If the inspector finds that any feature is “Not in Compliance”, for example, and he needs to order a replacement part in which to make the feature in compliance, then the system will record that information and generate the appropriate Failed Inspection notifications and reports. Additionally, the APP will prompt the inspector to enter in the repair that is necessary, such as “schedule painter,” “schedule locksmith,” “schedule repair to replace kickplate.” Upon subsequent repairing of the door so that the feature is now “in compliance,” appropriate notifications, reports, and updates may be made. The scheduled repair may be tracked therefore by both the inspector and the customer via the customer web-based app.

As more and more fire doors have sensors, it is contemplated that a Wi-Fi based sensor assessing whether the door is propped open or is not fully latching, and certain other elements be in communication with the app to alert the customer-side app if the door is propped open or not closing and latching properly.

After the completion of adding the photograph(s) and/or video(s), the physical “inspection” steps performed by the inspector of the first door are substantially done. Next, the system will prompt the inspector to enter additional doors and then the inspector will review and submit his inspection.

The inspector may be prompted if there are additional doors to be inspected at the same location. If so, the inspector “adds” a door to the same client, such as per the below screen shot. The inspector then repeats the inspection steps with information from the “additional” door(s) until there are no remaining doors to be inspected at that location. Once there are no additional doors to be inspected at this location, the inspector will review and sign.

The inspector may then add several email recipients of the inspection report, in the same manner as has been described in connection with the automatic door inspection steps. Additionally, at this point, the inspector can select a door that has been through the inspection steps to review and retrieve more information about that inspection.

The report is prepared to be sent to one or more email recipients, including the inspector's and/or the customer's email. Additionally, the report may be sent to the Authority Having Jurisdiction (AHJ) at this step. The inspector is directed to submit reports. He can also view the submitted reports online from this screen. Finally, the inspector can select a feature that eliminates this last step by selecting “automatically submit reports.” Finally, the inspector is then directed to return to the main screen.

The inspection is now complete. If the inspector has checked “automatically submit reports”, his report will be submitted automatically, and he will not see this screen at this point. If the Auto-Submit option is not selected, or the inspector is selecting it for the first time, he may select “Submit Reports” and then “Return to main screen” when done.

Similar to the automatic door Inspection Report, and Inspection Report associated with a fire-type door may be generated using the systems and methods of the present invention, a sample report is generated as a pdf document that can be emailed by the inspector and/or customer as appropriate and stored in the customer's database for retrieval.

The Inspection Report includes photographs and/or videos and includes the GPS locator information associated with the inspection, using “LAT” and “LNG” coordinates. All the captured data is populated in the Inspection Report, including the Customer Order, Work Order, Date, Status of the Inspection, Inspector information, Client information, and Door Information.

Additional data may be included in the sample Inspection Report including the Inspection Results, Inspector/Operator Adjustments, Inspector Comments, Signage Results, and an overall Completeness Check.

The system and methods of the present invention allow for real-time inspection of fire doors and the capture and distribution of the data, information, and results associated with that inspection. The system and methods of the present invention allow for inspection of fire doors that is compatible with industry standards, including those of the NFPA. It is contemplated that when a standard is changed or updated, that the app is also updated.

The method of capturing data associated with a fire door inspection has been described as if this was the inspector's first time inspecting a fire door with the APP. It is contemplated that upon subsequent inspections, some of the data may be automatically populated by the APP as appropriate, meaning that, upon the entering of a customer number or door identification number, information about that door may appear populated on the APP. Further contemplated is an optional step that prompts the inspector if he has inspected the fire door in the past. If the inspector selects “yes” to that question, the GPS locator information is used to identify the facility and/or door so as to pre-populate the demographic information and thus make the subsequent inspections more efficient. Other variations of pre-populating some of the door data are contemplated herein.

Customer Web Application

On the client-, customer-, facility owner-, and/or property manager-side of the system and method is cloud-based web application that may be accessed via any appropriate computer device. For ease of reference, this user will be labeled the “customer”, although it is understood that this user may be of several varieties, such as a property manager, owner, or the like. The customer may also be an individual that supplies inspection services or a manager of inspectors. The customer may also be an organization, such as an AHJ, or a body that certifies inspectors. The present invention is not limited by the identity of the “customer” and considers other users to be covered herein. The customer may also have one or more users as appropriate. For example, there may be a global administer for a particular organization and several accounts associated with that organization. For ease, only a single user will be discussed herein.

An appropriate portal will be provided, such as the one available from DoorIQ, having a website at https://app.mydooriq.com/ herein incorporated by reference in entirety. The customer would log onto the web-based app. As with the app that is run on the facility's site to handle the inspection, the web-based app is agnostic and is compatible with all Certifying Bodies, and can be used whether the doors at the facility or fire-type and/or automatic doors.

The customer has to perform certain steps upon his/her initial registration, such as selecting a subscription model (and thus pricing model), agreeing to terms and conditions, and adding payment information. Other typical demographic information is collected, including the customer's address and email addresses. A confirmation email may be used at registration. A customer number or corporate ID number will be created and associated with that particular customer. Once the account is verified, the customer may log in.

The user may add information about one or more inspectors. The customer may enter all demographic details of the inspector, a photograph of the inspector's certificate, and expiration date of the inspector's certificate maintained by an appropriate organization, such as a Certifying Body, such as the Door Security & Safety Foundation, NFPA, IFDIA and/or ALOA.

Each inspector must renew and/or complete their license periodically with an appropriate certification organization. For example, each inspector must receive a new certification every two years. The system and method of the present invention will track the expiration of these certifications and generate appropriate reminders to both the customer and the inspector himself about certification. For example, a notification may be sent about six months before a certification is about to expire. Other automatic notifications associated with the inspector's certification may be generated. Additionally, a report can be run by a customer for all certifications that are set to expire in a certain time frame.

It is contemplated that the customer and/or inspector may be able to communicate to/from a database of certifications. For example, if an inspector renews his certification with a Certifying Body, such as NFPA or ALOA, NFPA or ALOA would communicate that information to the customer and/or the inspector via the system and methods described herein. The expiration date associated with the inspector's certificate would then be updated. In the automatic door space, there are about 6,000 certified door inspectors in the United States and Canada that are registered with AAADM. In the fire door space, there are about 20,000 certified door inspectors in the United States.

Returning to the customer's web-based system, the customer also enters the email address of the inspector or inspection company. The inspector will receive an email with instructions for downloading the app and registering. This email will contain a Passcode that allows the inspector to be associated with that customer. Multiple inspectors can be associated with multiple customers. Customers can control which inspectors or inspection companies that it will allow to inspect. Customer will continue to “Add Inspector” via the web-based system until all inspectors are added.

In retrieving, reviewing, and using Inspection Reports, the user may also be able to attach his company's logo to the Inspection Report, before sending or printing. The Inspection Reports may be aggregated by date, by door, or the like.

The customer may search for and retrieve Inspection Reports, using any relevant search term, including the customer number, work order number, the date, the inspector, or the like. As discussed herein, the Inspection Report is valuable business record in the case of any accident involving the facility or door.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method of capturing, organizing, storing, and distributing data related to automatic door inspections in one or more buildings at one or more facilities by one or more inspectors comprising:
having a first inspector physically inspect a first automatic door on site at a first facility, wherein the first inspector uses a remote smart device to enter data about the first automatic door, including selecting a type of automatic door being inspected, associating the first automatic door to a first customer, entering real time data about the first automatic door, including at least the closing speed of the first automatic door, recording the GPS location of the first automatic door, and taking at least one of a photograph or video of the first automatic door;
transmitting the entered data about the first automatic door to a database; and
allowing the first customer to access the entered data in the database through a web-based user interface.

2. The method of claim 1, further comprising repeating the inspection steps for two or more automatic doors.

3. The method of claim 1, further comprising two or more inspectors.

4. The method of claim 1, further comprising two or more customers.

5. The method of claim 1, further comprising generating an inspection report that includes the real time data about at least the first automatic door after the transmitting step.

6. The method of claim 1, wherein at least one photograph and at least one video is captured during the inspection of the first automatic door.

7. The method of claim 1, wherein the data entered about the first automatic door further includes compliance information relating to the door's sensor.

8. A method of capturing, organizing, storing, and distributing data, information, and results related to fire, smoke, or egress door inspections in one or more buildings at one or more facilities by one or more inspectors comprising:
having a first inspector physically inspect a first fire, smoke, or egress door on site at a first facility, wherein the first inspector uses a remote smart device to enter data about the first fire door, including selecting a type of fire door being inspected, associating the first fire door to a first customer, entering real time data about the first fire door, including at least the door clearances, the door's frame, and the door's operation, recording the GPS location of the first fire door, and taking at least one of a photograph or video of the first fire door to evidence compliance or non-compliance with fire codes and regulations;
transmitting the entered data about the first fire door to a database; and
allowing the first customer to access the entered data in the database through a web-based user interface.

9. The method of claim 8, further comprising repeating the inspection steps for two or more fire, smoke, or egress doors.

10. The method of claim 8, further comprising two or more inspectors.

11. The method of claim 8, further comprising two or more customers.

12. The method of claim 8, further comprising generating an inspection report that includes the real time data about at least the first fire door.

13. The method of claim 8, wherein at least one photograph and at least one video is captured during the inspection of the first fire door.

14. The method of claim 8, wherein the data entered about the first fire door further includes information about the door's signage, hardware, and glazing.

15. A system of capturing, organizing, storing, and distributing data, information, and results related to door inspections for doors that need to be regularly inspected according to code or regulation in one or more buildings at one or more facilities by one or more inspectors comprising:
a remote smart device associated with a first inspector, wherein the first inspector physically inspects one or more doors, wherein a first door is on site at a first facility, wherein the first inspector enters data about the first door using the remote smart device, including selecting a type of door being inspected, associating the first door to a first customer, entering real time data about the door, including at least the door's operation, recording the GPS location of the first door, and taking at least one of a photograph or video of the first door to evidence compliance or non-compliance with codes and regulations;
a database which receives and organizes the entered data about the first door from the remote smart device; and
a first customer device that allows the first customer to access the entered data in the database through a web-based user interface.

16. The system of claim 15, further comprising two or more inspectors.

17. The system of claim 15, further comprising two or more customers.

18. The system of claim 15, further comprising generating an inspection report that includes the real time data about the first door.

19. The system of claim 15, wherein the first door is an automatic door.

20. The system of claim 15, wherein the first door is a fire, smoke, or egress door.
